(19) United States
(12) Patent Application Publication
(10) Pub. No.: US 2007/0277858 A1
(43) Pub. Date: Dec. 6, 2007

(54) DEVICE FOR WASHING VEHICLES

(76) Inventor: Alberto Soria, Torino (IT)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/697,887

(22) Filed: Apr. 9, 2007

(30) Foreign Application Priority Data
Apr. 22, 2006 (EP) 06 008 367.2

(51) Int. Cl. B08B 13/00

(52) U.S. Cl. 134/63

(57) ABSTRACT

The present invention concerns a “tunnel” device for external washing of vehicles. The device consists of a series of stations (S1, S2), in which phases of the process for washing the vehicle (V) are carried out, and means for driving a vehicle through the stations. The device is provided with at least one horizontal brush (6) for cleaning the vehicle (V). The brush is mounted transversely with respect to the direction (F) of transport of the vehicle (V) on support means (61, 62, 63), which support it with respect to the vehicle (V), which is being pulled by the drive means (2). In at least one station there is a plurality of spray nozzles (7) to spray the driven vehicle (V) with sprays (71) of a wash liquid. Advantageously, the spray nozzles (7) are mounted on support means (62, 63) for the horizontal brush (6) and are movable via said means with respect to the vehicle (V).

### CROSS-REFERENCE TO RELATED APPLICATION

This application claims priority under 35 U.S.C. §119 to European Patent Application No. 06 008 376.2 filed Apr. 22, 2006, the entire contents of which are incorporated herein by reference.

### FIELD OF THE INVENTION

The present invention concerns a device for washing vehicles as in the generic part of claim 1.

### BACKGROUND OF THE INVENTION

Currently there are devices available on the market that enable vehicles to be washed automatically, for example, automobiles, small vans and pickup trucks, delivery vans, trucks in general, etc.

Usually such devices consist of a number of automatically rotating brushes, spray nozzles supplied with water and/or a washing agent liquid and blowers to dry the vehicle. The brushes, nozzles and blowers are arranged in “stations” within a structure that is designed as a tunnel or stretches out like a series of “arches.”

The vehicle to be washed is transported into the tunnel or through the arches by a mechanical conveyor device, for example, a belt that pulls a front wheel of the vehicle, which is in neutral gear. Each station has the function of carrying out a particular treatment on the vehicle. For example, the tunnel can consist of a prewash station, a brush wash station, a rinse station and a station for final drying. The washed vehicle is transported out of the tunnel device by the conveyor device for return to the customer.

The tunnel or arch device, which is usually installed in service stations, in shopping centers, and so forth, makes it possible to wash vehicles in a short time without requiring the participation of staff.

The rotating brushes are mounted horizontally and vertically on movable supports. At least two vertical brushes (specifically, with essentially vertical axes of rotation) usually have the function of each brushing on a side of the vehicle, while at least one horizontal brush (horizontal axis of rotation), which is held in a position transverse to the direction of transport of the vehicle in the tunnel, has the function of brushing the hood, the windshield, the top, the rear window, and possibly the trunk of the vehicle.

With the previously known traditional washing devices, the support arm for the horizontal brushes is a cross strut affixed to the tunnel structure or the related portal structure in order to be able to move back and forth over the vehicle in the course of travel through the tunnel, where it remains in contact with the body through the effect of the force of gravity that acts on the arm and on the brush. In other words, the horizontal brush is affixed to the upper part of the structure of the device like a pendulum and swings over the vehicle, which is in motion, pushed by the body of the vehicle itself, where it nevertheless remains in contact with the vehicle and its contour.

In recent years this technical solution was abandoned in order to improve the quality of the wash. In newer wash devices the holders or cross struts are actuated by motors or by equivalent servo mechanisms in order to bring the pertinent rotating brush into contact with the vehicle body. During the transport of the vehicle in the tunnel or between the arches the support holder for the vertical brushes approaches the vehicle from the side, while the support cross strut for the horizontal brush approaches the vehicle body from above with an exclusively vertical motion. In this embodiment the horizontal brush is indeed generally supported by a cross strut, the ends of which are affixed to the posts of the relevant portal or to the walls of the tunnel with the capability of sliding.

The motion of the holders or the cross strut for support of the brush is affected by an appropriate control system, which consists of a number of sensors, for example, position and/or proximity sensors, photocells, etc. In this form it is possible to move the holders and the cross struts so that the contact between the brush and the vehicle body is optimum for all vehicles regardless of body shape. In other words, the holders and the cross strut are moved so that the brush follows the shape of the vehicle body as it is transported in the tunnel. The control system keeps the brushes from coming too close to the body or the relevant holders (or cross strut) for support of the brushes from coming into damaging contact with the body.

The sensors detect the position of the vehicle and the brushes and generate a signal that is appropriately processed by the control system for feedback actuation of the motors for the holders and the cross strut.

A control system that is analogous to the one used by the brushes is provided to control the motion of at least part of the nozzles with which the traditional washing devices are provided.

In the traditional washing devices, the prewash station, which is one of the initial stations, is provided with a number of spray nozzles that direct a liquid onto the vehicle under pressure for the purpose of producing a first cleaning of the body. The liquid is usually water or a washing agent or a mixture of the two liquids.

Recently the use of prewash stations that are provided with nozzles that supplied with liquids at high pressure, generally water, the pressure of which is in the range of 60-80 bar, has become common. This configuration proved to be especially efficient, with regard to the quality of the washing of vehicles.

The spray nozzles of the prewash station are usually immovably arranged on a horizontal cross strut, which is disposed transversely to the direction of transport of vehicles through the device. The cross strut moves vertically and is affixed at its ends to two supports of a portal that is specifically provided for its support. The nozzles direct the wash liquid in the direction of the vehicle, which is being pulled in the direction of the station.

Initially the holder is in its lower position, for example, at the height of the front grill of the automobile that is to be washed, and the nozzles strike the front part of the vehicle with their respective sprays. As the vehicle is transported in the direction of the nozzle support cross strut, when the spacing has decreased to a preset interval, the control system actuates the motors that control the vertical motion of the cross strut. The cross strut is lifted in order to enable the passage of the automobile through the prewash station under the nozzles. Then the cross strut returns to the initial position in order to initiate a new wash cycle on a different vehicle.

The shifting of the cross strut is controlled by the control system so that the distance between the nozzles and the vehicle body essentially remains constant. The control system makes use of suitable sensors to measure the position of the vehicle and the nozzle support cross strut, for example, position sensors, proximity sensors, photocells, etc., and of a unit that stores the shape of the vehicle profile.

The traditional wash devices have various disadvantages, which are primarily connected with the reliability of the components and the washing quality, namely with the effectiveness of cleaning the body of the vehicle being treated.

The control system for movement of the holders and the cross strut that supports the brushes or the spray nozzles is easily susceptible to errors. The atmosphere within the tunnel, or at any rate in the vicinity in the device, is especially humid in operation. The nozzles spray really large quantities of liquid, which evaporates in the air, and which also carries the washing agent, possibly mixed with water, that otherwise is on the vehicle body. Under these conditions the sensors easily get dirty, the metallic components and electrical connections as well as the electronic switches oxidize. In other words, when the wash device is in operation the atmosphere in which the control system operates is aggressive and with time easily gives rise to malfunctions.

In addition, the control system is difficult to adjust and to maintain. Usually the control of the automatic tunnel washing device is entrusted to a person who has little competency in the electronics field. The maintenance of the control system, both ordinary maintenance and extraordinary maintenance in the case of defects, therefore has to be entrusted to a trained technician. This has a negative effect on the costs of controlling the device.

The motors and the mechanical devices that are used to move the brush and nozzle support holders are subject to shortcomings. Frequently, dust, mud and residues removed from the vehicle body by the brushes or the water sprays collect in the machinery for rotating the holders and for lifting the cross strut, which gives rise to malfumctions, excess wear of parts, adjustment errors, etc.

Another disadvantage is given by the fact that the sprays that leave the nozzles of the prewash station strike the different zones of the vehicle body at different angles. For example, the sprays strike the hood of a vehicle at an impingement angle that is smaller than the impingement angle of the same sprays when they strike the top or the windshield of the same vehicle. The effectiveness of the sprays in cleaning the body therefore is not the same over the entire surface of the vehicle, but rather varies from one part to another.

U.S. Pat. No. 5,613,260 has a device for washing vehicles with a series of stations, in which phases of the process of washing the vehicle are carried out with means for driving a vehicle through the series of stations and with a horizontal brush for cleaning the vehicle. This brush is mounted transversely with respect to the direction of transport of the vehicle, on support means which support it in reference to the vehicle, which is being pulsed by the drive means. Here there are spray nozzles to strike the passing vehicle with sprays of a wash liquid, which are mounted on support means for the horizontal brush and which are movable with it with respect to the vehicle, specifically by rotation along an axis.

### SUMMARY OF THE INVENTION

The objective of the present invention is to make available a device for washing vehicles, especially automobiles, that remedies the disadvantages of the traditional devices in a simple and efficient way and that at the same time is economical to realize and to control.

Another objective of the present invention is to make available a device for washing vehicles, especially an automatic tunnel or portal device, that makes it possible to obtain optimum performances with respect to the effectiveness of the cleaning treatment of the vehicle and with regard to the maximum reliability.

Still another objective of the present invention is to make available a device for washing vehicles that is provided with spray nozzles for prewashing or for rinsing, in which the sprays supplied from the spray nozzles clean the surface of the vehicle essentially with the same effectiveness.

This and other purposes are achieved by the present invention, which concerns a device for washing vehicles as in claim 1.

Advantageously, the nozzles are affixed to the carrier structure for the horizontal brushes and do not require a special carrier structure for them. Besides having the function of brushing the body of the vehicle being washed, the horizontal brush functions as a “follower” element that follows the profile of the body, and the motion of the cross strut for holding the spray nozzles is guided.

The described configuration, which calls for the installation of the spray nozzles on the carrier structure for the horizontal brush, makes it possible to direct the sprays generated by the nozzles toward the vehicle without using a traditional and costly purpose-related system for control of the motion of the nozzles with respect to the vehicle. In general, therefore, the cross strut for support of the nozzles is carried by the structure for support of the horizontal brush.

For this reason another objective of the invention is the use of the structure for support and movement of a horizontal rotating brush in a wash system as a means for support and moving of one or more spray nozzles for spraying the body of the vehicle to be washed.

In the preferred embodiment of the present invention the motion of the horizontal brush is also not controlled by a suitable control system. In particular, the horizontal brush is mounted on a boom structure, i.e., the ends of the cross strut for support of the brush are affixed to a support that is supported at the upper end of the tunnel or the portal. The supports are provided with counterweights, which are arranged on the part opposite the hinge from the horizontal brush. Besides the rotation at the support cross strut, the brush describes a circular path that oscillates in the direction of transport of the vehicle, guided by the supports.

Initially the brush is in its lower position, and the boom structure is in the vertical position under the effect of its own weight. When a vehicle is pulled through the station and comes into contact with the horizontal brush, the brush follows the upper profile of the vehicle body. In other words, the brush is supported at the vehicle and the boom structure swings due to the effect of the pull of the vehicle in transport, which lifts the brush. The result is the brush, which is activated for rotation, cleans the vehicle body as it is transported. When the vehicle crosses through the station, the boom structure swings into the initial position.

The motion of the horizontal brush is not controlled by motors, servo mechanisms or electronic control systems. The structure for support of the horizontal brush works through the effect of gravity, which acts on it, and through the force exerted on the brush by the vehicle that is passing through the wash station.

Through the spray nozzles on the boom structure for support of the horizontal brush, the wash device turns out to be extremely simple, easy to realize, reliable, and economical to control.

Preferably, the spray nozzles are supplied with liquid elevated pressure, for example, water, at 60-80 bar. The nozzles are arranged in groups on the relevant support cross strut. Each group directs the water sprays in the direction of adjacent parts of the vehicle body.

The effectiveness of the sprays in cleaning the body can be maximized by movable (orientable) nozzles. The nozzles of a given group are arranged along a common axis, for example, an axis perpendicular to the cross strut of the support, and rotate about said axis due to the “fan-like” motion of the sprays on the body of the vehicle being washed.

Besides the fact that it is more reliable than traditional devices, the wash device in accordance with the present invention makes it possible to wash vehicles effectively. The quality of the washing process is increased by the fact that the sprays are directed onto the different parts of the body of the vehicle at essentially a constant impingement angle.

One or more nozzles are mounted on the support cross strut in a position and orientation so that the relevant sprays are directed toward the rear window and the rear of the vehicle, as it passes through the station. In other words, a first plurality of nozzles is oriented toward washing the vehicle that is approaching the horizontal brush, while a second plurality of nozzles is arranged in the direction opposite the first plurality of nozzles and is oriented to wash the rear of the vehicle when the horizontal brush is acting on the rear (or the rear window) of the vehicle.

The horizontal brush which is moved on the vehicle like a follower element (contour follower) keeps the nozzle support cross strut essentially at the same distance from the body during its motion with reference to the vehicle (where the variations in size that are caused by the deformation of the bristles of the brush are neglected). Also, the impingement angle of the sprays onto the body remains almost constant during the passage through the station by the vehicle, with obvious advantages for the uniformity of washing. The rotary motion of the spray nozzles is in the direction transverse to the direction of transport of the vehicle and essentially does not modify the impingement angle of the sprays on the body, which however contributes to optimizing the effectiveness of the prewash process.

### DETAILED DESCRIPTION OF THE INVENTION

Other aspects and advantages of the present invention result more clearly from the following description, which is carried out for explanation and not to limit the invention, with reference to the attached schematic drawings, where:

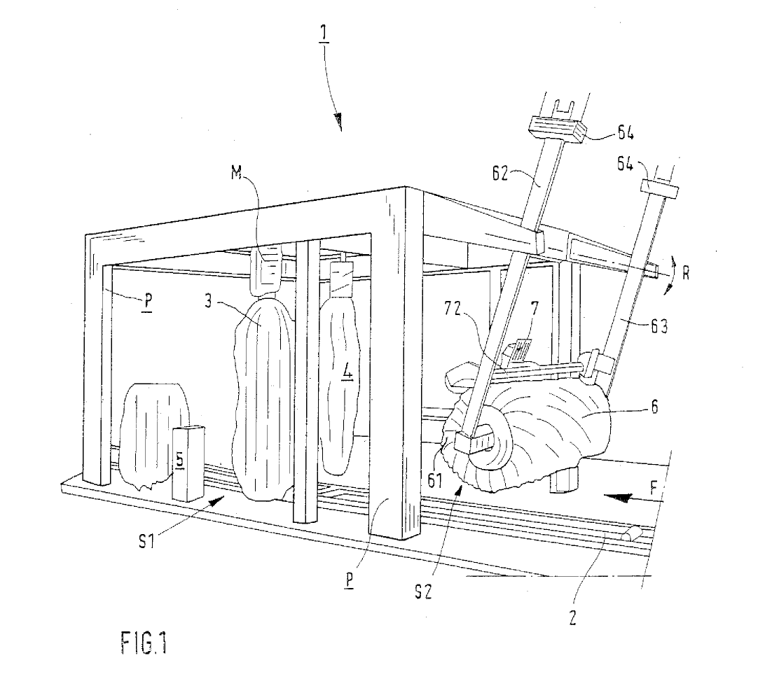

FIG. 1 is a perspective view of a device for washing vehicles in accordance with the present invention;

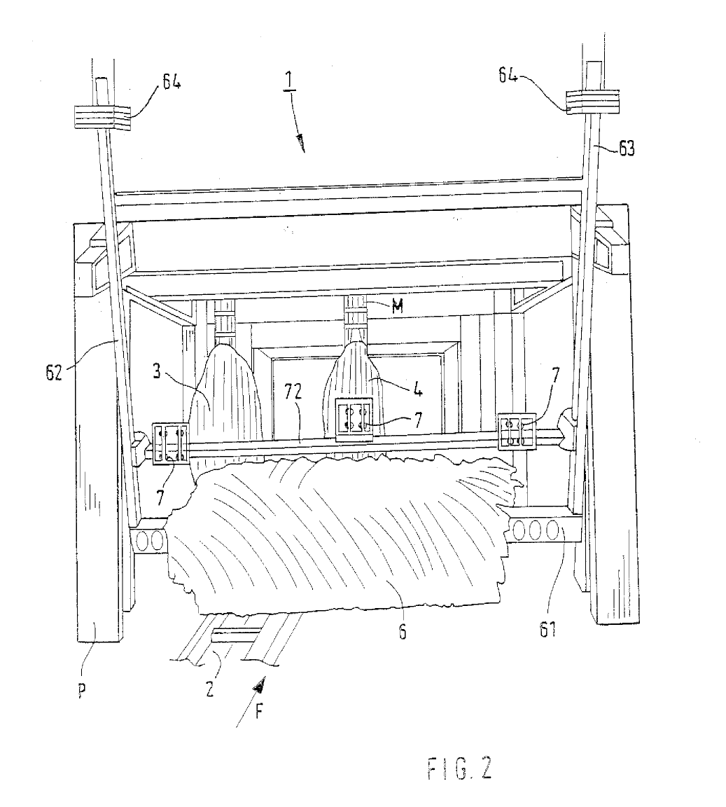

FIG. 2 is a front view of the device shown in FIG. 1;

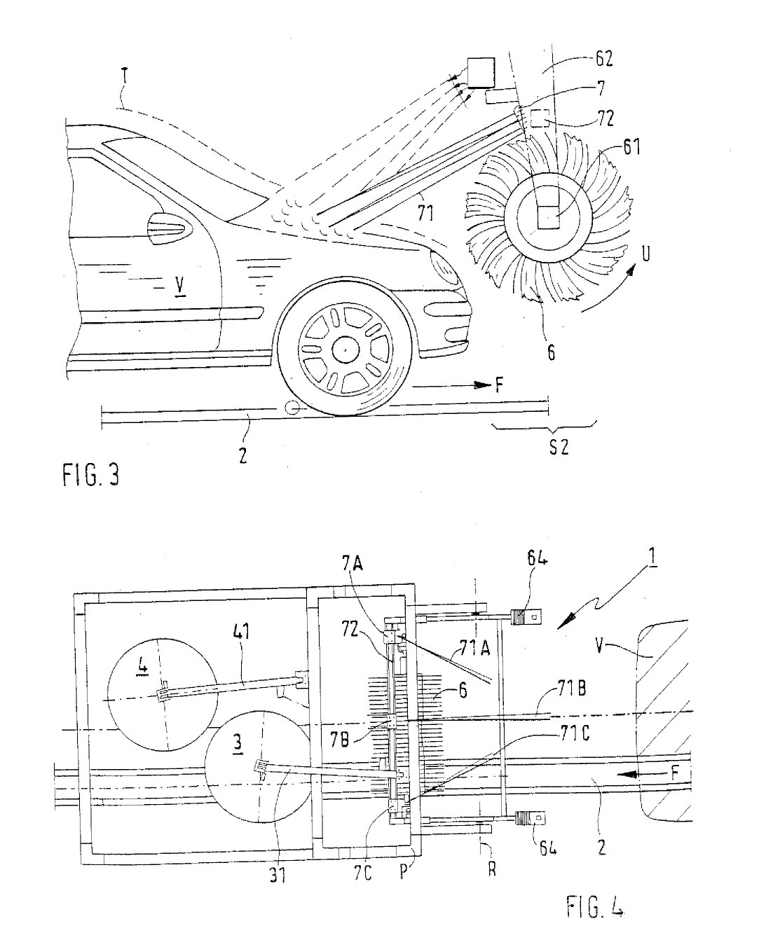

FIG. 3 is a side view of a detail of the device shown in FIG. 1, in operation;

FIG. 4 is a schematic top view of a device in accordance with the present invention;

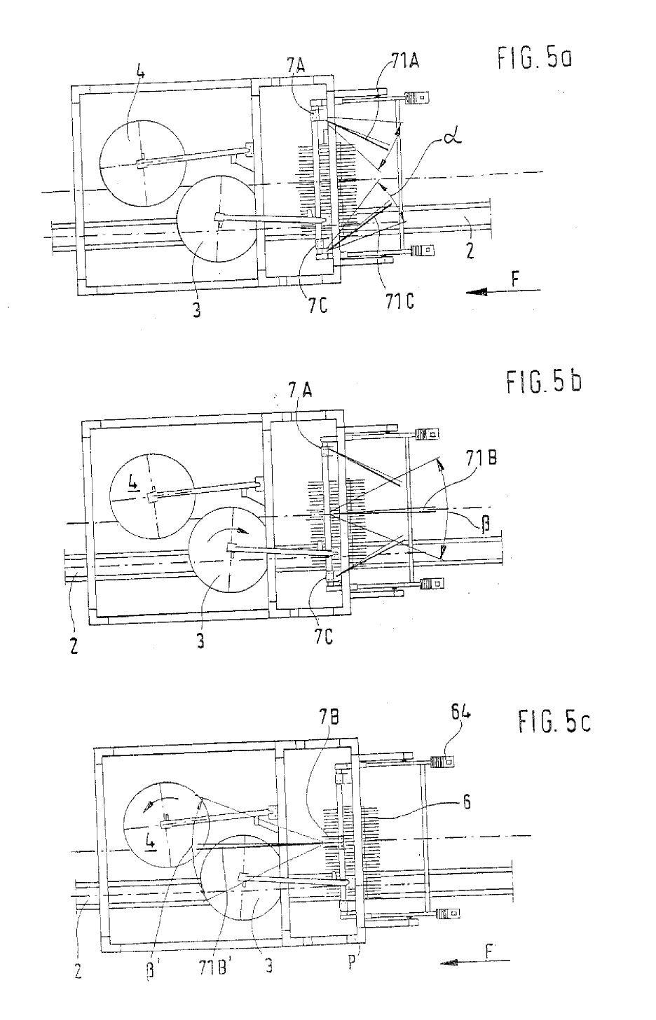

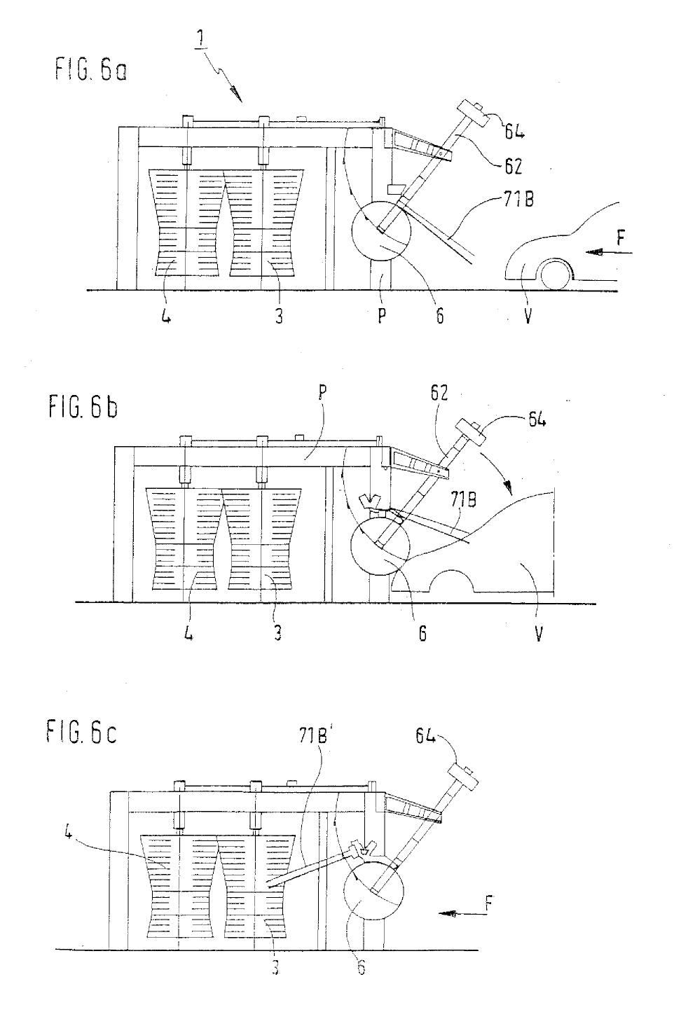

FIGS. 5a-5c are schematic top views of the device shown in FIG. 4;

FIGS. 6a-6c are schematic side views of the device shown in FIG. 4.

In FIG. 1 a wash device 1 in accordance with the present invention for personal vehicles and automobiles in general is shown in perspective view. The wash device 1 has a traditional “tunnel” structure, which is formed of a series of arches P. A conveyor device 2 has the task of pulling the vehicles through device 1 in the direction of transport F at the necessary speed.

The device consists of a number of “stations,” each of which is set up to carry out a treatment of the washing process. The device 1 shown in the figure consists of a first wash station S1 and a second wash station S2 which are arranged in a series.

Station S1 is provided with two vertically rotating brushes 3 and 4, each of which is operated by a motor M. The vertical brushes 3 and 4 are supported on vertical carriers, for which a suitable control system 5 serves to push them together toward the vehicle as it passes through station S1. The vertical brushes clean the sides of the vehicle.

Wash station S2 is provided with a horizontally rotating brush 6, which is supported in the direction transverse to the direction of travel F of the vehicle being washed. FIG. 2 is a front view of device 1, which shows station S2 in detail.

The horizontal brush 6 has the task of cleaning the upper part of the vehicle body starting from the front grill and progressing to the hood, the windshield, the top, the rear window and the rear of the vehicle.

In general, brush 6 can be supported on a traditional structure with vertical members. Preferably, the horizontally rotating brush is supported on a boom support structure, as shown in FIGS. 1 and 2.

The boom structure consists of a cross strut 61 to support the brush 6 (the brush rotates on cross strut 61), which is affixed at its ends to two supports 62 and 63. Supports 62 and 63 in turn are supported on portal P of station S2 in order to be able to rotate freely about axis R. In other words, supports 62 and 63 and the support cross strut 61 are affixed to structure P of the device in order to be able to swing like a pendulum in direction F.

Suitable counterweights 64, for example, cement blocks, are affixed to supports 62 and 63 at the end opposite cross strut 61 from the support point. The counterweights balance the weight of the support structure with respect to the axis of rotation R.

The boom structure that supports the horizontal brush 6 is pushed into rotation by the vehicle in the washing process. FIG. 3 schematically shows a vehicle V in the vicinity of wash station S2. When the front portion of vehicle V comes into contact with brush 6, the brush “climbs” up the vehicle body. In other words, brush 6, which is initially in its position at a minimum height with respect to the floor, is shifted in direction U by the effect of the thrust that the vehicle V exerts on the boom support structure, which rotates upward. When the vehicle V progresses through station S2, brush 6 follows the profile of its body like a “follower” element (contour follower), and it describes a path T with respect to vehicle V.

Advantageously, the motion of the boom system that supports the horizontal brush 6 does not require the intervention of a control system that instantaneously establishes the position of the brush with respect to the vehicle in order to realize possible compensations of the preset parameters. The support structure for brush 6 is precisely “balanced” and the oscillations of the result of an important balance between gravity that acts on said structure (group 6, 61, 62, 63) and its counterweights 64 and the thrust exerted on brush 6 by the vehicle V.

The structure of station S2 is thus extremely simple to implement and set up. Also, maintenance station S2 is simply carried out, since there are no complicated sensors or a control unit.

Advantageously, the device 1 in accordance with the present invention is provided with a plurality of nozzles 7, which are mounted on the support structure for the horizontal brush 6, to direct sprays 71 of a wash liquid in the direction of the vehicle V.

The wash liquid can be water or a washing agent or a mixture of the two. Preferably, nozzles 7 are provided with water at high pressure, which is compressed, for example, in an interval of 60-80 bar.

Nozzles 7, which are provided for prewashing vehicle V, specifically have the Unction of carrying out an initial washing of the vehicle body before the engagement of brush 6 and move together with brush 6 with respect to vehicle V. Nozzles 7 are preferably arranged in groups on a cross strut 72, which is firmly joined to supports 62 and 63 of the boom system that supports horizontal brush 6. In this form the nozzles operate optimally without requiring a purpose-related control system suitable for control of the motion, as is provided, however, in the traditional devices.

Another advantage that device 1 claims over traditional solutions lies in the fact that the sprays 71 onto the body of vehicle V at an impingement angle that is essentially constant or that varies in an interval of a few degrees. In FIG. 3 the nozzles 7 are moved with the brush 6 when the horizontal brush 6 follows path T with respect to the body of vehicle V which is in motion and the nozzles follow the course of the contour of vehicle V, always remaining at the same distance (where the variations in size of the bristles of brush 6 are neglected). Also, the orientation of the nozzles with respect to the different parts of the body remains essentially unaltered as the vehicle V passes through. For example, the windshield of the vehicle is slanted with respect to the hood. Sprays 71 strike the hood of vehicle V in FIG. 3 at an impingement angle of roughly 40°. When brush 6 is lifted in order to clean the hood of the vehicle, nozzles 7 are also lifted and sprays 71 are directed toward the windshield at an impingement angle of roughly 43°, thus with a minimum variation with respect to the previous value, which is provided for washing the hood. The effectiveness of washing that can be obtained with sprays 71 is therefore uniform for the different regions of the body of vehicle V.

FIG. 4 is a diagrammatic sketch of the device 1 seen from above. One can see the support holders 31 and 41 for vertical brushes 3 and 4 and the conveyor device 2. Spray nozzles 7 are arranged in three groups 7A-7C on the support cross strut 72. Group 7A directs a spray 71A in the direction of vehicle V, which is formed of a number of sprays 71. Analogously, groups 7B and 7C direct sprays 71B and 71C.

The middle spray 71B is directed at vehicle V, while the side sprays 71A and 71C converge on the vehicle.

Nozzles 7 are rotatable about an axis in order to shift the relevant sprays 71. Preferably, each group of spray nozzles 7A-7C is rotatable about an axis that is perpendicular to cross strut 72. FIGS. 5a and 5b each show the angle α of oscillation of sprays 71A-71C and the angle β of the oscillation of the front spray 71B.

Advantageously, device 1 is provided with some spray nozzles 7′ that are oriented so that the relevant sprays 71 are directed toward the rear of the vehicle which approaches the passageway of station S2.

FIG. 5c shows the oscillation angle β′ of middle rear spray 71B′, which has the function of washing the rear part of the vehicle V as it leaves station S2.

FIGS. 6a-6c are schematic side views of device 1. In particular, FIG. 6a shows the radius of rotation of the boom structure that supports horizontal brush 6 during its oscillation at the vehicle V. The function of the compensation of the rotational weight of counterweights 64 that are attached to the ends of support 62 and 63 can be seen. FIG. 6a shows the vehicle V transported in the direction of the horizontal brush 6 in its lowered resting position. FIG. 6b shows the vehicle V while it comes into contact with the brush 6 that has been activated for rotation. The further transport of vehicle V determines the swing of supports 62 and 63 of the support structure of brush 6, which begins to follow the profile of the vehicle body. When the vehicle passes across brush 6, for example, when the brush is cleaning the rear window of the vehicle, the rear nozzles 7B (FIG. 6c) are activated and provide for the center rear spray 71B′ to be directed toward the window.

Device 1 has an extremely simple structure and its function does not require the use of expensive and complicated electronic control systems. The performance of the device with respect to effectiveness of the cleaning of vehicles is elevated. The reliability of the device is considerable and maintenance is simple and can be conducted by nonspecialized personnel.

1. A device (1) for washing vehicles (V) with a series of stations (S1, S2), in which phases of the process for washing the vehicle (V) are carried out, with means for driving (2) a vehicle (V) through the series of stations (S1, S2) and at least one horizontal brush (6) for cleaning the vehicle (V), where the horizontal brush (6) is mounted transversely with respect to the direction (F) of transport of the vehicle (V) on support means (61, 62, 63), which support it with respect to the vehicle (V) that is being pulled by the drive means (2), where in at least one (S2) of the stations a plurality of spray nozzles (7) is present in order to strike the driven vehicle (V) with sprays (71) of a wash liquid, where the spray nozzles (7) are mounted on the support means (62, 63) of the minimum of one horizontal brush (6) and are movable with it with respect to the vehicle (V) and where the spray nozzles (7) are in groups and are arranged along an axis, about which they are rotatable, characterized by the fact that the axis of each group of nozzles is perpendicular to the axis of the horizontal brush (6).

2. A device as in claim 1, characterized by the fact that the horizontal brush is rotatably mounted on a forward cross strut (61), which slides vertically on the structure of the device (1).

3. A device as in claim 1, characterized by the fact that the horizontal brush (6) is rotatably mounted on a forward cross strut (61), which is held at the ends of supports (62, 63), which are supported on a portal (P) and are provided with counterweights (64) in order to form a boom system.

4. A device as in claim 3, characterized by the fact that the boom system swings in the direction (F) of transport of the vehicle under the thrust that is exerted on the horizontal brush (6) by the vehicle (V).

5. A device as in claim 3, characterized by the fact that the spray nozzles (7) are mounted on a second cross strut (72), which are affixed to the supports (62, 63) in an intermediate position with respect to the brush (6) and the axis of rotation (R) of the supports (62, 63).

6. A device as in claim 1, characterized by the fact that the spray nozzles (7) are in groups and are arranged along an axis, where they are rotatable about said axis.

7. A device as in claim 1, characterized by the fact that the spray nozzles are supplied with the wash liquid, the pressure of which lies in the interval of 20-100 bar.

8. A device as in claim 1, characterized by the fact that the spray nozzles (7) in the direction of the sprays (71) of the wash liquid are oriented toward the vehicle (V) at an essential constant impingement angle.

9. A device as in claim 1, characterized by the fact that at least one spray nozzle (7) is oriented toward the rear part of the vehicle (V) to direct the spray of wash liquid.
